(19) United States
(12) Patent Application Publication
(10) Pub. No.: US 2008/0197557 A1
(43) Pub. Date: Aug. 21, 2008

(54) Computer enabled document sequencing and decollation by reference to a rulebase

(76) Inventor: Benjamin Khuu, Grand Rapids, MI (US)

Correspondence Address: MORRISON & FOERSTER LLP, 755 PAGE MILL RD, PALO ALTO, CA, 94304-1018, US

(21) Appl. No.: 11/708,764

(22) Filed: Feb. 20, 2007

(51) Int. Cl. B65H 83/00; G06F 7/76

(52) U.S. Cl. 271/3.2; 700/213

(57) ABSTRACT

Method and apparatus for computer enabled sequencing and later desequencing of multiple electronic documents or their physical embodiments in a specific order, either in preparation or in actualization of transmission or storage, and decollation of those documents in the specified order. The sequence in which the documents are placed is determined by a computer process that reads a rulebase whose content determines the document sequence. The computer process uses that sequence to physically order the documents in either their magnetic or physical embodiments or both. Because of the resemblance to a stack of paper reports, this sequencing is referred to as “stacking”, and the decollation process is referred to as “unstacking”. The method uses software components identified as a rulebase creation application, a rulebase, a rulebase reading application, a document sequencer (“stacker”), a stack index, and a complementary document decollator (“unstacker”).

### FIELD OF THE INVENTION

This disclosure relates to computer enabled document management.

### BACKGROUND

Many office work practices require the production of large numbers of documents. These documents, in general, are intended for use by one or more individuals, organizations, or functional units within organizations. The individuals, organizations, or functional units may use the documents in varying orders. The documents are often produced in electronic PDF (“Portable Document File”) format or other common computer file format, or may be produced as paper documents. One example of such a work practice is the origination and processing of mortgage loan documents, but examples from other industries and businesses abound.

The office work practices referred to above share a common need to create documents or cause them to be created, to direct them, or cause them to be directed, to the correct locations. During such a work process, the document creator or someone under that person's direction captures information from a plurality sources, including, for example, customers, financial institutions, insurance agencies, and government agencies, enters the information into a computer, and uses the computer to generate the documents mentioned above. The documents may be created either as electronic files or as paper embodiments of those files. The documents are then transmitted, either physically or electronically or by both modalities, to the other individuals, organizations, or functional units. Documents may be transmitted for instance as a sequence of individual files or documents, or as a batch (group) of related files or documents—both being referred to here as a “stack”. It is common current practice in many such industries to merge such documents together into a single file, such as, but not limited to, a PDF format file. In such industries, the resulting PDF may be thought of as a single “stacked” document without “staples” to delimit the component documents.

Individuals, organizations, or functional units who receive such documents, typically receive a great many of them per week. In general, the order in which documents must be processed is not arbitrary. For example, a business agreement may not be able to be finalized until financial institutions agree, which may, in turn, depend on insurance being bound, which may, still further, depend on government regulator approval, etc. For these reasons, the order in which documents are sequenced for transmission can either facilitate the efficient processing of the documents or frustrate it, if the documents arrive in an order that does not replicate the order of the tasks to be performed with them (e.g., the “stack” is not in a useful order). Further, since visual recognition of documents is the primary means not only for insuring proper processing and routing but for decollating (“unstacking”) documents from a “staple-free” stack, and since many documents may appear visually similar, both non-optimal sequencing and also erroneous decollation of documents can and does occur, leading to wasted time manually sorting documents in many offices, as well as increased error rates. This wasteful expenditure of time and increased error rate can, in addition to increasing costs, cause needless slowing of throughput. Prior solutions in this area consist of ad hoc stacking, with no particular attention given to an orderly, reproducible, editable process for achieving the “stacking” results, and imperfect, ad hoc methods of unstacking.

The present inventor has determined that a way to solve the problems of wasted time, increased chance of error, and slowed throughput due to suboptimally sequenced and/or merged documents is to create a computer enabled process by which the document ordering sequence can be specified for use by, e.g., the computer used to create the documents (e.g., the documents are “stacked” efficiently) and the computer used to receive and unstack the documents for distribution to their designated destinations. That process is the subject of the present disclosure.

### SUMMARY

The present disclosure relates generally to the stacking (sequencing or collating) of a plurality of electronic documents and, optionally, the physical embodiments of those electronic documents resulting from printing the electronic documents, in a specific order, either in preparation for or in the acts of transmission, storage, and/or the unstacking (decollating or desequencing) by an end user, and to the actual decollation of those documents. (Note that the complement of sequencing, also called collating, is also termed desequencing. In this field, the term decollation is also used for this process.) The sequence in which the documents are placed (stacked) is determined by a computer process that reads a rulebase whose content determines the document sequence. The originating computer process uses that sequence to physically or synoptically order the documents in either their magnetic embodiments and, optionally, the physical embodiments of those electronic documents resulting from printing those documents, or both. This is referred to as “synoptically” because, for example, even files on a hard disk drive are not necessarily physically sequenced in any special order. In general, files are typically referenced by pointer tables that may be collated in any special order. So the stacking also applies to the use of a rulebase to create an access or transmission order, without necessarily requiring physical ordering. Because of the conceptual resemblance to a “stack” of paper (hard copy) documents, this sequencing is referred to here as “stacking”. The receiving computer reverses the process by partitioning the received file into its original components by using the same sequencing information. By analogy with the use of the term “stacking” to create the original order, this reverse process is referred to here as “unstacking”.

In one embodiment, for example, where the “stacking” is accomplished by having the stacking software create a pointer table consisting of a sequence of page counts—i.e., a table whose lexical meaning is: “the first document consists of 3 pages“; “the second document consists of 12 pages”, and so on—the unstacking is accomplished by causing a software application to read the stacked document page-by-page and, relying on the pointer table to create a self-contained document consisting of the first 3 pages of the stacked document, followed by a self-contained document consisting of the next 12 pages of the stacked document, and so on.

The present invention is directed to a computer enabled process by which the sequence in which a plurality of documents are ordered (“stacked”) prior to transmission or storage for later use is specified and controlled and by which later the documents, upon receipt, are decollated (unstacked) back into their original form.

The disclosed process uses a rulebase, an application (computer program) for creating that rulebase, a rulebase reader, a document sequencer (the “stacker”) that responds to the results of reading the rulebase, one or more metadata record(s), collectively referred to in this document as the stack index, that list the order and size of the stacked documents and represent the results of the application of the rulebase, and a document decollator (the “unstacker”) that responds to one or more components of the stack index, all in the form of a computer program or programs (software) optionally plus data or metadata, executable by a conventional computer or by a special purpose computer.

The rulebase may have various embodiments that include computer text files, binary files, or files containing both text and binary items. The rulebase may also consist of more complex computer files such as XML (eXtensible Markup Language) files, relational database files, including event triggers and stored procedures, or other types of data or metadata files. The rulebase could also consist of a script file for the sequential creation of the documents in the proper order. The application (software) for creating the rulebase may have various embodiments that include locally based applications, web based applications, or a hybrid of the two. The rulebase reader may have various embodiments that include, but are not limited to, a script parser that accesses the rulebase, a print driver that accesses the rulebase, or a script importer that imports a script or script skeleton from the rulebase. The document sequencer (“stacker”) may have various embodiments that include multiple sequential invocations of the document creation command, for example, “Print”, instructions to a complex printer driver capable of accepting a list of documents, or even multiple sequential invocations of larger processes including embedded document creation commands.

The Stack Index may have various embodiments that include, for example, independent files, such as XML or INI files, containing such items as, such as page number or byte offset pointers, embedded tags or markers, such as XML tags, or unique character or checksum sequences. In alternative embodiments, data or metadata with substantially the same information may be also contained within the document files themselves, for example, by the use of PDF bookmarks and tables of contents, or they may consist of simultaneous embodiments with redundant information for use in different unstacking processes. For example, PDF bookmarks and tables of contents may be used to allow a user to read a stacked file, while a text based INI file may be read by a browser to allow a user to unstack the documents in a web based environment.

The document decollator (“unstacker”) may have various embodiments such as a reader for the Stack Index, followed by multiple invocations of a “Print” command, or other methods for routing unstacked documents to the appropriate locations and/or users.

### BRIEF DESCRIPTION OF THE DRAWINGS

FIG. 1 shows graphically the present document sequencing (“stacking”) process and associated system.

FIG. 2 shows graphically the present document decollating (“unstacking”) process and associated system.

FIGS. 3a-3e show a user interface for the FIG. 1 system.

FIGS. 4a-4c show a user interface for the FIG. 2 system.

### DETAILED DESCRIPTION

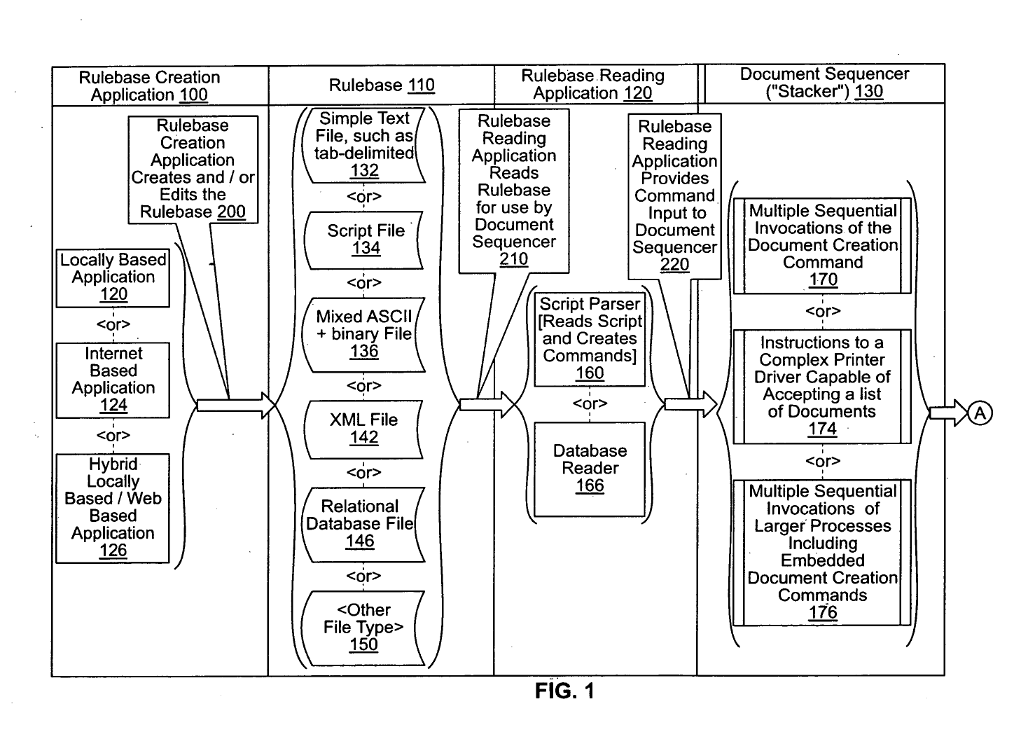

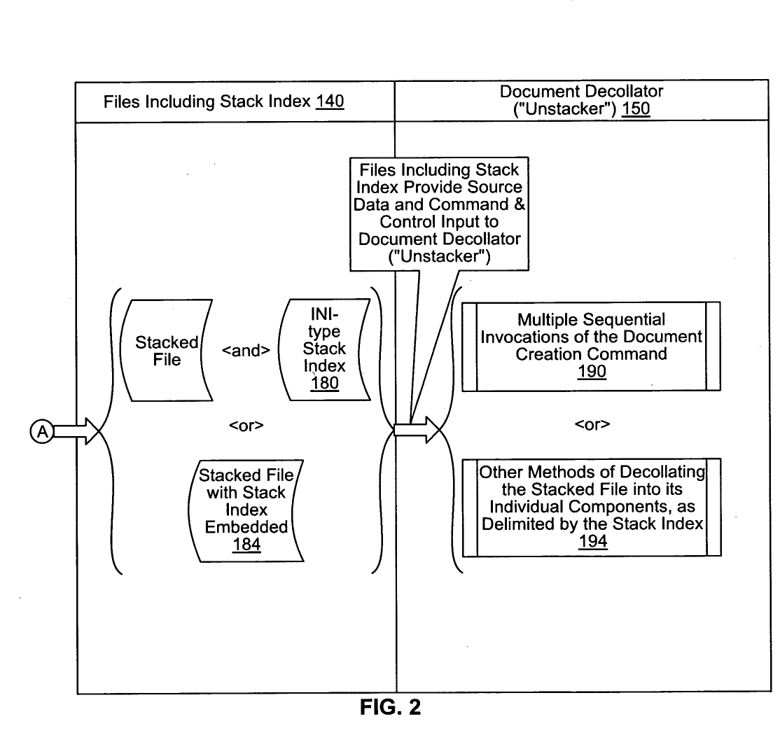

The present process uses in one embodiment several components and associated processes. FIG. 1 illustrates graphically the present document sequencing (“stacking”) process and system. In this process, a rulebase creation application (program) 100 creates and/or edits at 200 a rulebase 110 using one or more alternative conventional computer enabled processes, such as, for example, text editing or binary compilation. (Conventional aspects of the associated computer hardware and software of these components and/or processes, such as an operating system, input/output, program configuration, registry, disk, memory, processor, etc. are omitted for ease of illustration.) The rulebase reading application (program) 120 reads at 210 the rulebase software and provides at 220 command input to the document sequencer program (“stacker”) 130, which produces the documents in the order prescribed by the rulebase 110 (“stacks” the documents) and creates a Stack Index 140 (see FIG. 2), which is the record of information needed by the unstacker.

Reference herein to “one embodiment,” “an embodiment,” “some embodiments,” or similar formulations, means that a particular feature, structure, operation, or characteristic described in connection with those embodiments, is included in at least one embodiment of the present invention. Thus, the appearances of such phrases or formulations herein are not necessarily all referring to the same embodiment. Furthermore, various particular features, components, operations, or characteristics may be combined in any suitable manner in one or more embodiments.

A first main component of the system is the rulebase creation application 100, which accepts data input from users that determines the sequence in which the documents to be produced will be ordered (“stacked”). For example, the user may presented with a Graphical User Interface containing a complete list of available documents along with a sequencing tool, such as numbers associated with each document, a drag-and-drop metaphor, or other similar embodiment. In all cases, the user's input is captured by application 100 and used to create a machine-understandable rulebase. This application 100 may have several alternative forms. In embodiment 120 it is locally based, meaning that its executable code, libraries, and metadata exist on a local computer or network of computers. In embodiment 124 it is remotely based and accessible over the Internet as a web-based application. In embodiment 126 it uses both techniques together. The effect of any of the embodiments is to capture the input of a user as regards a specified sequence for document production and store at 200 that input data in the rulebase 110.

A second main component is the rulebase 110, which is the repository for the data input captured by the rulebase creation application 100. This rulebase may have several alternative embodiments. It should be noted that the files below, and others similar to them, qualify as “databases” under the industry standard meaning of that term.

One such embodiment is tab delimited text file 132 of FIG. 1, in which all data is stored as a sequence of ASCII character representations, such as:

Tab-Delimited Text File Example:

| | | |
|---|---|---|
| DocumentName2 | 1 | 12 |
| DocumentName5 | 13 | 15 |
| DocumentName1 | 16 | 16 |
| DocumentName3 | 17 | 20 |
| DocumentName4 | 21 | 31 |

In this embodiment, the order of documents captured from the user's input is represented by the order in which the documents are listed, and the beginning and ending page numbers of each document is provided by simple integer values on the same line with each document's name.

Yet another embodiment of the rulebase 110 is a script file 134, such as for a printer:

Another embodiment of the rulebase 110 of FIG. 1 is a mixed ASCII and binary file 136, of the type:

Mixed ASCII and Binary File Example:

Mixed ASCII/Binary: 44 6f 63 75 6d 65 63 74 4d 61 6d 65 32 09 01 09 0c
Decoded equivalent: D o c u m e n t N a m e 2 <tab>1 <tab>12
Mixed ASCII/Binary: 44 6f 63 75 6d 65 63 74 4d 61 6d 65 35 09 0d 09 0f
Decoded equivalent: D o c u m e n t N a m e 5 <tab>13 <tab>15
Mixed ASCII/Binary: 44 6f 63 75 6d 65 63 74 4d 61 6d 65 31 09 10 09 10
Decoded equivalent: D o c u m e n t N a m e 1 <tab>16 <tab>16
Mixed ASCII/Binary: 44 6f 63 75 6d 65 63 74 4d 61 6d 65 33 09 11 09 14
Decoded equivalent: D o c u m e n t N a m e 3 <tab>17 <tab>21
Mixed ASCII/Binary: 44 6f 63 75 6d 65 63 74 4d 61 6d 65 34 09 15 09 1f
Decoded equivalent: D o c u m e n t N a m e 4 <tab>21 <tab>31

In this embodiment, the order of documents captured from the user's input is represented by the order in which the documents are listed. The names of the documents, which in this embodiment serve as the identifier for each document, are shown as their ASCII code letter equivalents. The beginning and ending page numbers of each document are represented as hexadecimal integer values on the same line with each document's name, separated by tab characters. It should be noted that the ASCII representations are similar to the hexadecimal representations for the SIMPLE TEXT FILE above, but that the binary representations of numbers differ from the ASCII representations shown in the SIMPLE TEXT FILE example.

Another embodiment of the rulebase 110 is an XML file 142 of FIG. 1. This type of file contains only ASCII characters, but its internal complexity is significantly greater than that of the simple ASCII file mentioned above. In an XML file (see following), certain information is designated as metadata—data about data—and such metadata controls the way the remaining data is interpreted. The schemes for interpretation can be quite complex, and are contained in repositories either locally or remotely, including on the Internet.

XML File Example:

```
<?xml version=“1.0” encoding=“ISO-8859-1” ?>
- <!--
Edited with XML Spy v2007 (http://www.altova.com)
-->
- <rulebase>
    <job>
        <jobname>Example</jobname>
        <jobcontents>
            <documentname>DocumentName2</ documentname>
            <start-page>1</start-page>
            <end-page>12</end-page>
            <documentname>DocumentName5</ documentname>
            <start-page>13</start-page>
            <end-page>15</end-page>
            <documentname>DocumentName1</ documentname>
            <start-page>16</start-page>
            <end-page>16</end-page>
            <documentname>DocumentName3</ documentname>
            <start-page>17</start-page>
            <end-page>21</end-page>
            <documentname>DocumentName3</ documentname>
            <start-page>21</start-page>
            <end-page>31</end-page>
        </jobcontents>
    </job>
</rulebase>
```

In this embodiment, the order of documents captured from the user's input is represented by XML tags that can be read by any XML utility that has been provided with their meanings.

Yet another embodiment of the rulebase 110 is a relational database file 146 (e.g., SQL). This type of file contains both ASCII and binary components, but its internal complexity is significantly greater than that of any type of simple file, and qualitatively different from that of the XML files mentioned above. In such a database file, the information is interpreted according to structural information in the rest of the file and in companion files, see FIG. 2. In this embodiment, file names are stored in a table identified by a UNIQUE_ID, and their page lengths are stored in another table also identified by the same corresponding UNIQUE_ID. A QUERY is created, with the documents in the preferred order, shown with UNIQUE_ID and computed values StartPage and EndPage.

Yet another embodiment of the rulebase 110 is a script, such as for a printer:

Script Example (For a PDF Printer Driver):

open(PDF01 , “StackIndex”, new)

open(PDF02, “LargeDocument”, new)

print(PDF02, “LargeDocument”,“DocumentName2”, append, pagesprinted: “StackIndex”)

print(PDF02, “LargeDocument”, “DocumentName5”, append, pagesprinted: “StackIndex”)

print(PDF02, “LargeDocument”, “DocumentName1”, append, pagesprinted: “StackIndex”)

print(PDF02, “LargeDocument”, “DocumentName3”, append, pagesprinted: “StackIndex”)

print(PDF02, “LargeDocument”, “DocumentName4”, append, pagesprinted: “StackIndex”)

close(PDF02, “LargeDocument”, save)

close(PDF01, “StackIndex”, save)

In this example, the script does not correspond precisely to any set of device commands for any currently manufactured printer driver. Rather, it is created for a hypothetical PDF printer driver with multiple document stream capability and parameters similar to those in many commercial printer drivers. Its purpose is to be translated into script that such a printer actually CAN understand. When read by the rulebase reading application [below], the script will cause the Stacker to open two documents. One, “LargeDocument”, on stream PDF02, will receive the output of each document to be stacked. The other, “StackIndex”, on stream PDF01, will receive the “pagesprinted” output parameter in a sequence of write operations. Finally, both documents will be closed.

Yet another embodiment of the rulebase 110 is any other file type 150. This refers to any of the multitude of rulebase storage strategies that have been created by various authorities.

A third main component (see FIG. 1) is the rulebase reading application (program) 120. This application may have one of several embodiments. Embodiment 160 is a script parser that reads information from the rulebase 110 that allows it to create a script by adding other information. Using the example of the script parser above, this embodiment would respond by opening a pair of documents, “LargeDocument” and “StackIndex”. It would then generate commands to the Stacker that would cause it to write Document2, etc., to LargeDocument, recording the number of pages produced in the StackIndex document. Finally, it would generate commands for the Stacker that would cause it to close both documents.

Another embodiment for the rulebase reading application 120 is a database reader 166 that would read a relational database embodiment of the Stack Index and convert it to commands that the Stacker would understand, resulting in the production of a stacked document.

A fourth main component is the document sequencer program 130 (“stacker”), which performs the operation of placing the plurality of documents in the order specified by the rulebase 110. This component may have several embodiments. Embodiment 170 is a sequence of several invocations of a document creation command, each with a specific document file as the target of the command, and with the effect of producing the desired sequence (“stack”) of documents in the desired order. This embodiment may be realized by the use of a script, or other means. Using the example of the script parser above, in response to the output of the rulebase reading application, this embodiment would create a pair of documents, “LargeDocument” and “StackIndex”. It would then write Document2, etc., to LargeDocument, recording the number of pages produced in the StackIndex document. Finally, it would close both documents.

Embodiment 174 of the document sequencer 130 (“stacker”) is a set of instructions created by the rulebase reading application 120 that is directly readable by a printer driver capable of accepting a list of documents, such as the Xerox Docutech series or other large printer. In this embodiment, the list of documents would correspond to the desired plurality of documents, in the order desired (the “stack”), and the result is the stacked document.

Another embodiment 176 of the document sequencer 130 (“stacker”) is a script reader that is capable of invoking stand-alone computer printing programs multiple times, including programs to create the desired plurality of documents in the order desired (the “stack”). In embodiment 176, the commands to create the documents are a part of the output from the rulebase reading application 120 instead of merely being a sequence of print commands as described above in the first embodiment of the document sequencer 130.

A fifth main component is the stack index 140 (see FIG. 2). The stack index 140 is a collection of metadata describing the individual documents within the stacked document and their physical extent within that stacked document. One embodiment of the stack index is an “INI” file 180, a text file similar to the Tab Delimited Text File example of the rulebase. This embodiment of the stack index differs from the above cited embodiment of the rulebase, however, in that the rulebase is intended to be used by the Stacker for purposes of ordering documents, whereas the stack index is intended to be used by the unstacker for the purpose of separating documents for routing or other types of use. Such an INI file can be read, for example, by a suitable browser, and can allow a human user to peruse the contents of the stacked documents, or it can be used to physically separate them for routing to appropriate offices, thru the use of a browser-based program.

Another embodiment of the stack index 140 consists not of a separate file, but rather of the collection of metadata contained within the stacked document 184, for example as PDF file format Bookmarks and Table of Contents. This embodiment of the stack index can be used by both human readers and also by programs that are designed to scan PDF tables of contents and bookmark inventories for markers and use the resulting information to decollate documents.

One embodiment 190 of the unstacker 150 is a sequence of several invocations of a document creation command, each with the stacked document file as the input source file of the data to be acted upon by the command, using and with the stack index used as the source of control information to delimit the extent portion(s) of the stacked document to be included in each derivative document, and with the effect of producing the desired sequence (“stack”) of documents in the desired order, embodied as multiple individual documents.

Another embodiment of the unstacker 150 is any other method of decollating the stacked file into its individual components, as delimited by the stack index. This embodiment may be realized by the use of a script, or other means.

Coding the above-described software components is routine given this disclosure; suitable computer languages include Java, C#, PHP, JavaScript, and supporting utilities, such as SQL Server, MySQL, various Web browsers, and multiple operating systems, such as Windows, MacOS, Linux, and Unix.

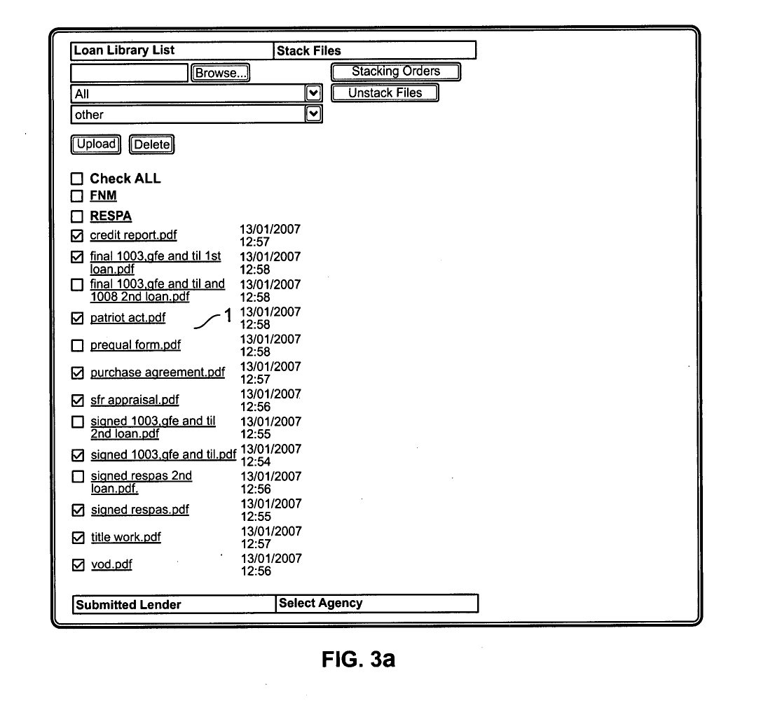

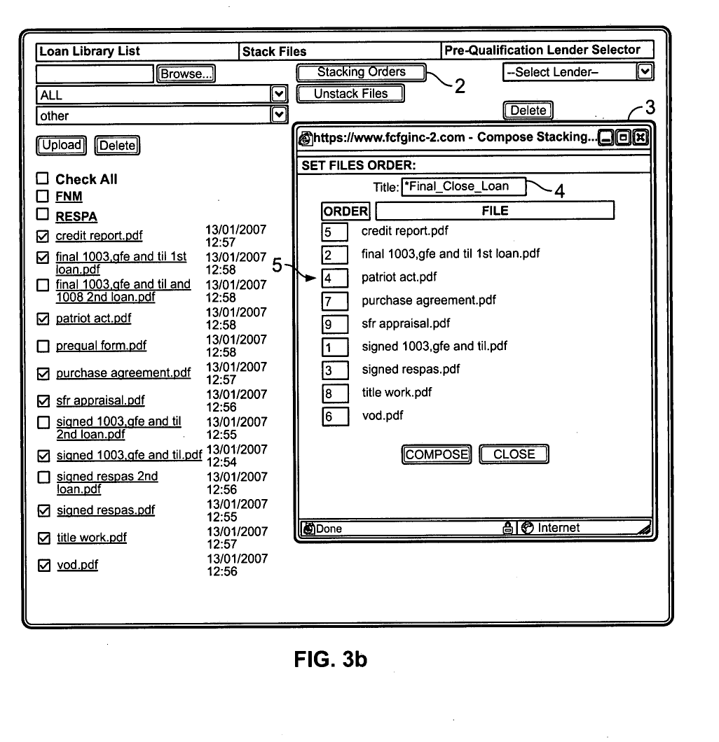

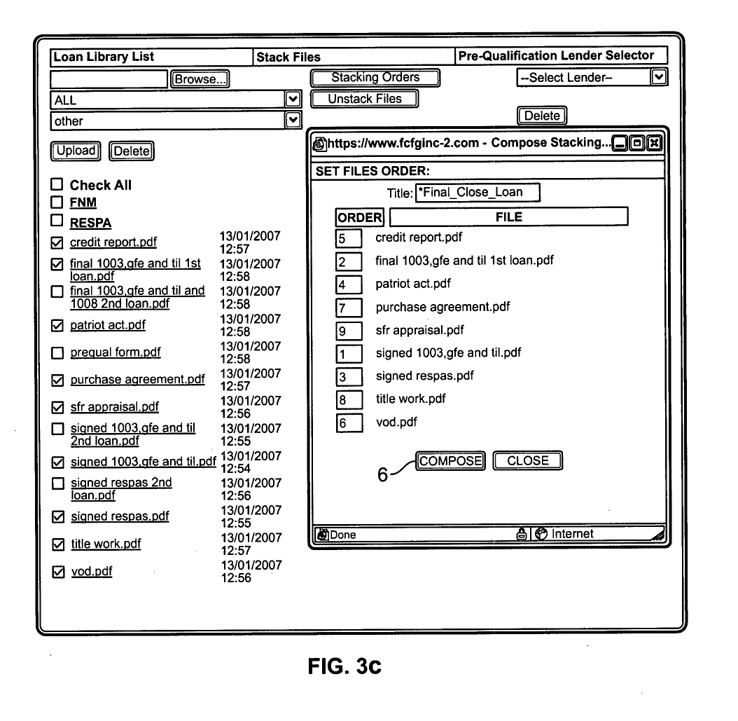

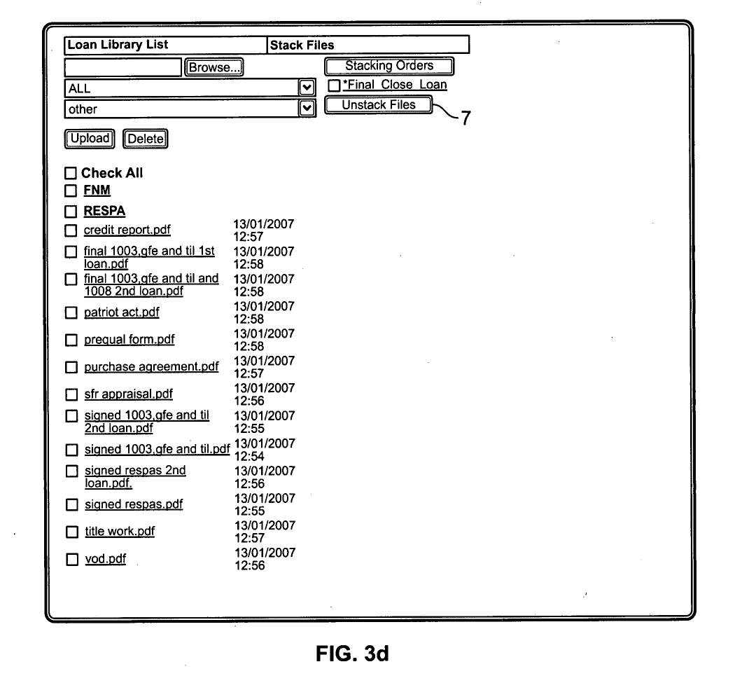

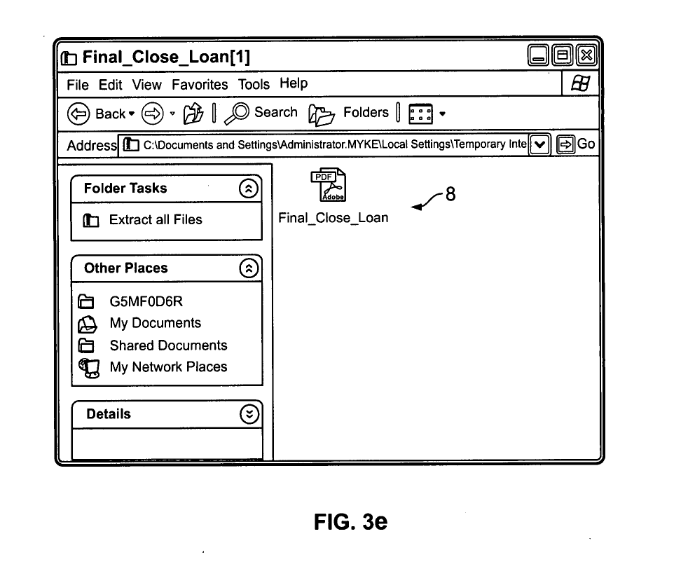

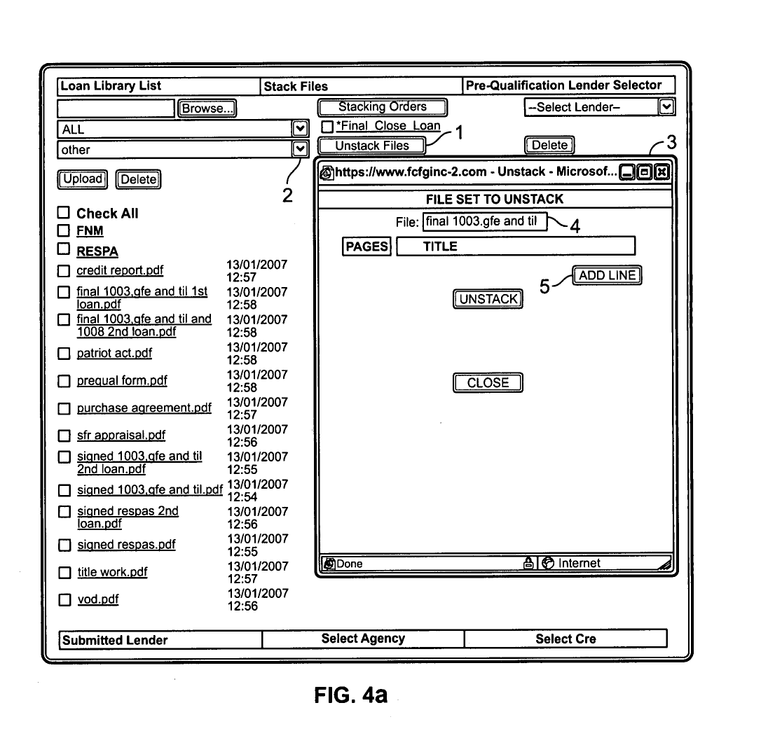

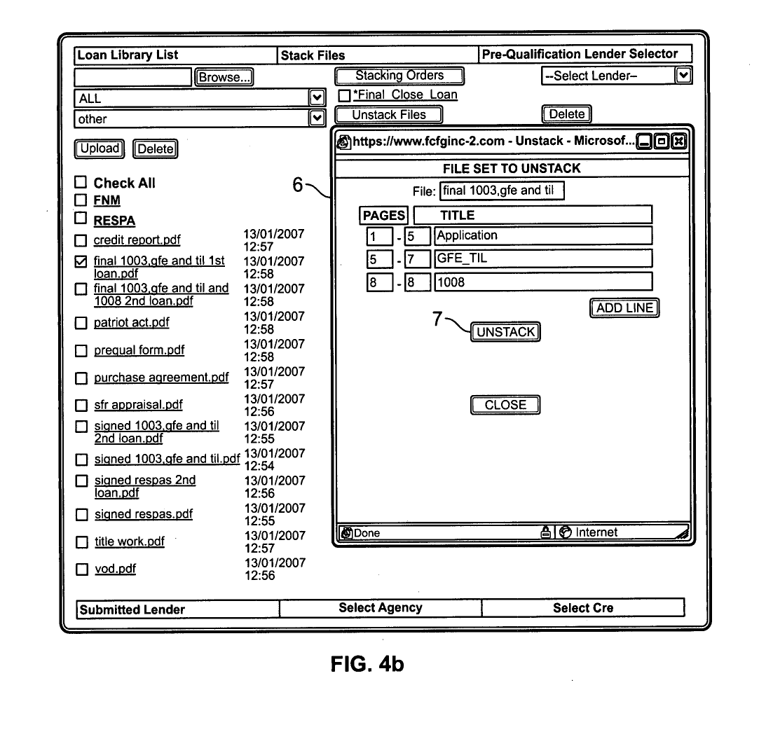

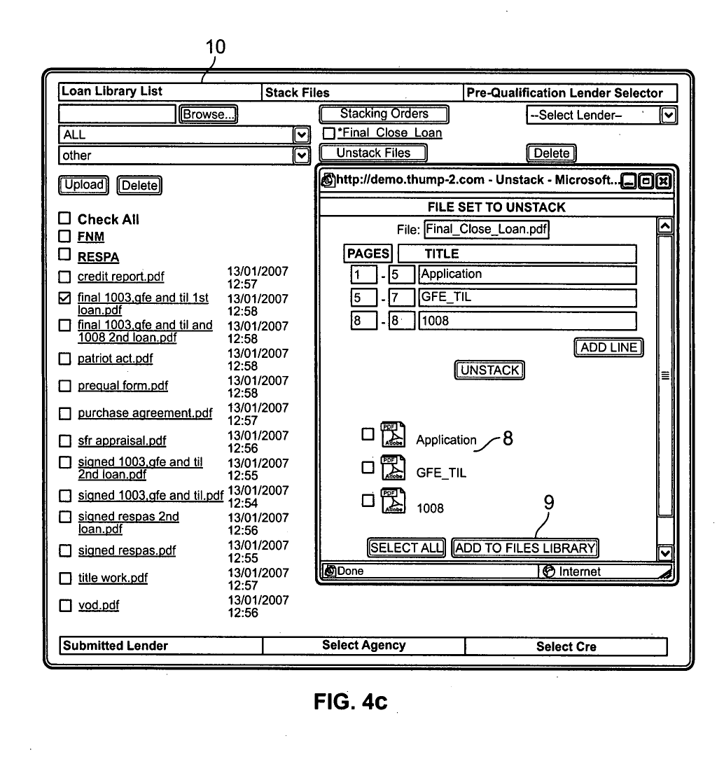

The user interface (interactive computer display screens which operate conventionally) for the system of FIGS. 1 and 2 is shown in respectively FIGS. 3a-3e and 4a-4c and is as follows for the above example of working with mortgage loan processing documents. FIG. 3a shows at (1) the first user interface computer display screen where the user starts with selecting from a list of files indicated along the left-hand side of FIG. 3a to be used for stacking. Then at FIG. 3b which is the next screen, after the list of files have been selected to be stacked, the user clicks on “Stacking Orders” indicated at (2). A pop-up window then opens as indicated at (3) with all of the files that were selected earlier displayed. The user then as indicated at (4) types in a name of the file that will be the stack name, in this case “Final Close Loan.” Then as indicated at (5) the user enters a number in each box in the “Order” column that will assign the sequence of each document listed to be stacked or displayed. That is, the user types these numbers into the boxes.

Then at FIG. 3c after all the files have been assigned a numeric number sequence, the user then clicks on the “Compose” button indicated at (6) at the bottom of the pop-up window and this causes the system to compress and stack all of the selected files. Then in FIG. 3d after the files have been stacked and compressed, the stacked file “Final Close Loan” indicated at (7) is displayed for the user to click. Then in FIG. 3e after the user clicks on “Final Close Loan” that opens into a readable conventional PDF file indicated at (8) where this PDF file includes all of the stacked documents.

FIG. 4a shows the first user interface display screen for the unstacking of the PDF file indicated at (8) in FIG. 3e. First, the user starts by selecting the file that needs to be unstacked indicated at (1) which is “Final Close Loan”. After he selects that, the user then clicks on the “Unstack Files” button indicated at (2) which opens the pop-up window indicated at (3). The user then sees the name of the file that will be unstacked indicated at (4). The user then clicks on the “Add Line” control indicated at (5) which provides a display of a row of text so that the user can number the order sequence to which he wants to extract the files. At FIG. 4b the user then enters a numeric number in the “Pages” column, in each text box, to allow the unstacker software to extract the current sequence of the documents and provide a name to that new file after it has been extracted unstacked indicated at (6). After the sequence of numbers have been entered and each file has been given a name, the user then clicks on the “Unstack” button indicated at (7) in the middle of the pop-up window. Then in FIG. 4c after the user has clicked on “Unstack” in FIG. 4b, the unstacker then displays a table with all of the extracted files that have been unstacked in the original file with the new file name indicated at (8). The user then can select any or all of the documents that have been unstacked or extracted and click on” Add To Files Library” indicated at (9). This file's “Library List” indicated at (10) is where all the files or selected files that have been extracted or unstacked will be saved.

This disclosure is illustrative and not limiting; further modifications will be apparent to one of ordinary skill in the art and are intended to fall within the scope of the appended claims.

What is claimed as new and desired to be protected by Letters Patent of the United States is:

1. Computer enabled method for processing a plurality of documents, comprising the acts of:
providing the documents;
creating a set of rules specifying an order of the documents;
reading the set of rules;
applying the set of rules to each document;
assigning a place in a sequence to each document according to the rules;
creating a stack including the plurality of documents, in the order specified by the rules; and
creating an index whereby the stack may be unstacked in the specified order.

2. The method of claim 1, further comprising providing a rulebase creation application to create the set of rules.

3. The method of claim 1, further comprising providing a rulebase specifying the rules.

4. The method of claim 1, further comprising providing a rulebase reading element to read the rules.

5. The method of claim 1, further comprising providing a document sequencer element to assign the place to each document.

6. The method of claim 1, further comprising the act of unstacking the documents.

7. The method of claim 6, further comprising the act of using the index to unstack documents.

8. The method of claim 6, further comprising providing a decollator to unstack the documents.

9. The method of claim 2, wherein the rulebase creation element is a locally based application.

10. The method of claim 2, wherein the rulebase creation element is an Internet based application.

11. The method of claim 2, wherein the rulebase creation element is a hybrid including a combination of a locally based and an Internet based element.

12. The method of claim 3, wherein the rulebase element includes at least one simple text file.

13. The method of claim 3, wherein the rulebase element includes at least one script file.

14. The method of claim 3, wherein the rulebase element includes at least one file containing binary data.

15. The method of claim 3, wherein the rulebase element includes at least one XML file.

16. The method of claim 3, wherein the rulebase element includes at least one relational database file.

17. The method of claim 4, wherein the rulebase reading element includes a script parser.

18. The method of claim 4, wherein the rulebase reading element includes a database reader.

19. The method of claim 5, wherein the document sequencer element includes multiple sequential invocations of a document creation command.

20. The method of claim 5, wherein the document sequencer element includes a printer driver capable of accepting a list of documents.

21. The method of claim 5, wherein the document sequencer element includes multiple sequential invocations of processes including embedded document creation commands.

22. The method of claim 6, wherein the unstacking includes multiple sequential invocations of a document create command.

23. The method of claim 7, wherein the unstacking includes a sequence of several invocations of a document creation command, each with the stack as an input source of the command, and using the index to delimit the extent of the stack to be included in a derivative document, thereby providing the sequence of documents in the desired order.

24. The method of claim 1, wherein the index includes a text-based file.

25. The method of claim 1, wherein the index includes PDF bookmarks and a table of contents.

26. The method of claim 7, wherein the decollator includes a sequence of several invocations of a document creation command, each with the stack as an input source of the command, and using the index to delimit the extent of the stack to be included in a derivative document, thereby providing the sequence of documents in the desired order.

27. A computer readable medium storing computer code for carrying out the method of claim 1.

28. A programmed computer, programmed to carry out the method of claim 1.

29. Apparatus for processing a plurality of documents, comprising:
a rulebase creation element that accepts data input from a user specifying a sequence of the documents;
a rulebase element coupled to the rulebase creation element, and that stores rules as to the sequence generated by the rulebase creation element;
a reading element coupled to the rulebase element, and that reads information from the rulebase element;
a sequence element coupled to the reading element, and that sequences the documents according to the read information; and
an indexing element coupled to the sequencing element, and that creates an index to the sequenced documents showing their order.

30. The apparatus of claim 29, wherein the rulebase creation element is one of a locally based application, a network based application, or a combination locally and network based application.

31. The apparatus of claim 29, wherein the rulebase element is one of a text file, a file containing binary data, an XML file, or a relational database file.

32. The apparatus of claim 29, wherein the reading element is one of a script parser or a print driver.

33. The apparatus of claim 29, wherein the sequencer element is one of sequential invocation of a document creation command, instructions to a printer driver, or sequential invocation of a process.

34. The apparatus of claim 29, wherein the indexing element is one of a text based file or a set of embedded metadata.

35. The apparatus of claim 29, further comprising a decollator couplable to the sequencing element and the indexing element and which unstacks the sequenced documents in the specified order.

36. The apparatus of claim 35, wherein the decollator includes a sequence of invocations of a document creation command.
